(19) United States
(12) Patent Application Publication
(10) Pub. No.: US 2014/0330873 A1
(43) Pub. Date: Nov. 6, 2014

(54) METHOD AND SYSTEM FOR DELETING GARBAGE FILES

(71) Applicant: ELECTRONICS AND TELECOMMUNICATIONS RESEARCH INSTITUTE, Daejeon (KR)

(72) Inventors: Myung Hoon CHA, Daejeon (KR); Hong Yeon KIM, Daejeon (KR); Young Kyun KIM, Daejeon (KR)

(73) Assignee: ELECTRONICS AND TELECOMMUNICATIONS RESEARCH INSTITUTE, Daejeon (KR)

(21) Appl. No.: 13/950,616

(22) Filed: Jul. 25, 2013

(30) Foreign Application Priority Data
May 3, 2013 (KR) 10-2013--0049990

(51) Int. Cl. G06F 17/30

(52) U.S. Cl. CPC G06F 17/30117
USPC 707/813

(57) ABSTRACT

A method and system that can completely delete garbage data in a distributed network system are provided. Because it is impossible to initially access a data server, data to delete is not deleted, and thus when a garbage file is generated, a generated garbage file can be completely deleted. In this case, by performing a deletion operation of a garbage file in a distributed data server unit, operation efficiency can be maximized.

### CROSS-REFERENCE TO RELATED APPLICATION

This application claims priority to and the benefit of Korean Patent Application No. 10-2013-0049990 filed in the Korean Intellectual Property Office on May 3 2013, the entire contents of which are incorporated herein by reference.

### BACKGROUND OF THE INVENTION

(a) Field of the Invention

The present invention relates to a method and system for deleting a file that is stored at a remote computer. The present invention is obtained from research that was performed for an industry fusion original technology development business of the Ministry of Knowledge Economy [subject number: 10041730 and subject title: Development of cloud storage file system for supporting simultaneous connection virtual desktop service of users of 10,000 or more].

(b) Description of the Related Art

A file system that distributes data to several computers that are connected with a network and that stores the data is currently being used. Such a file system may be operated with a method of storing metadata at some of several computers that are connected with a network and of storing data at remaining computers. Alternatively, a file system may be operated with a method of not separating a computer in which metadata is stored and a computer in which data is stored.

In a file system in which data is distributedly stored at a plurality of computers, when deleting specific data, because it is not always impossible to access a computer at which some of the specific data is stored, when the partial data is not deleted, even if it is possible to access the computer in which the partial data is stored later, the undeleted partial data remains in a garbage form. In this case, partial data remaining in a garbage form is referred to as garbage data.

When garbage data increases, there are various drawbacks in which storage space of a computer is wasted and in which a time that is consumed for restoring the computer increases.

A method of managing garbage data includes a method of updating distributedly stored files in computers that are connected with a network. According to the method, as an update operation is managed by control of a leased main chunk server, the distributedly stored files may be efficiently updated. However, the method cannot prevent a garbage file from remaining when completely managing an operation in which file deletion has failed.

Further, another management method of garbage data includes a method of removing a fragmentation phenomenon of a file. According to the method, in a plurality of disk drive systems, when operating a system, a file fragmentation phenomenon is removed by readjusting a size of a volume, which is space for storing data. That is, after a file is stored at a volume, when input/output of the file is continuously repeated, a fragmentation phenomenon occurs, and in this case, by adjusting a size of a volume block and by moving an existing file to correspond to a changed volume structure, a fragmentation phenomenon is removed and file input/output performance is optimized. However, the method cannot process a side effect when file deletion has failed.

### SUMMARY OF THE INVENTION

The present invention has been made in an effort to provide a method and system having advantages of completely deleting garbage data in a distributed network system.

An exemplary embodiment of the present invention provides a method of deleting data in a distributed network system. The method includes: attempting deletion of the data in a first data server in which the data is stored among a plurality of data servers; setting the data to garbage data when the data is not deleted in the first data server; storing information of the garbage data at a second data server of the plurality of data servers; and deleting the data from the first data server based on the garbage data when the first data server is restored.

The attempting of deletion of the data in the first data server may include searching for the plurality of data servers through metadata information representing position information of the data, and instructing deletion of the data to the first data server.

The setting of the data to garbage data may occur when the data is not deleted in the first data server when a network line to the first data server is unstable or when a fault occurs in hardware of the first data server.

The information of the garbage data may include an identifier and position information of the garbage data.

The storing information of the garbage data in the second data server may include determining the second data server based on a distance to the first data server, and storing information of the garbage data at the determined second data server.

The storing information of the garbage data in a second data server may further include determining the second data server according to a round robin (RR) scheduling method in the remaining plurality of data servers, excluding the first data server, and storing information of the garbage data at the determined second data server.

The deleting of the data from the first data server based on the garbage data may include periodically determining whether the first data server is restored, and deleting the data based on information of the garbage data when the second data server recognizes restoration of the first data server.

The deleting of the data from the first data server based on the garbage data may further include notifying, by the first data server, a data server that is included in the distributed network system of a restoration fact thereof; and deleting, by the second data server, the data based on information of the garbage data when the second data server recognizes a restoration fact of the first data server.

The deleting of the data from the first data server based on the garbage data may further include combining information of the garbage data including the same position information among the garbage data that is stored at the second data server and transmitting the information to the first data server, and deleting the data based on the information of the garbage data.

Another embodiment of the present invention provides a distributed network system that manages distributedly stored data. The distributed network system includes: a client server that searches for a data server in which the data is stored and that transmits a deletion command of the data and that sets undeleted data to garbage data, when the data is not deleted; a first data server that stores the data and that receives a deletion command of the data or the garbage data to delete the data; and a second data server that stores information of the garbage data and that transmits a deletion command of the garbage data to the first data server based on the information of the garbage data.

The distributed network system may further include a metadata storage unit that stores metadata representing position information of the data, and that transmits the metadata to the client server when a request of the client server exists.

The client server may set the undeleted data to garbage data when the data is not deleted in the first data server when a network line to the first data server is unstable or when a fault occurs in hardware of the first data server. The information of the garbage data may include an identifier and position information of the garbage data.

The client server may store information of the garbage data at a second data server that is determined based on a distance to the first data server.

The client server may store information of the garbage data at the second data server that is determined according to an RR method among the remaining plurality of data servers, except for the first data server.

The second data server may periodically determine whether the first data server is restored, and transmit a deletion command of the garbage data to the first data server when the first data server is restored.

The second data server may transmit a deletion command of the garbage data to the first data server, when the first data server notifies a data server that is included in the distributed network system of a restoration fact thereof.

### BRIEF DESCRIPTION OF THE DRAWINGS

FIG. 1 is a diagram illustrating a file system according to an exemplary embodiment of the present invention.

FIG. 2 is a flowchart illustrating a method of deleting garbage data according to an exemplary embodiment of the present invention.

FIG. 3 is a diagram illustrating garbage data information according to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

In addition, in the entire specification, unless explicitly described to the contrary, the word “comprise” and variations such as “comprises” or “comprising” will be understood to imply the inclusion of stated elements but not the exclusion of any other elements. In addition, the terms “-er”, “-or”, “module”, and “block” described in the specification mean units for processing at least one function and operation, and can be implemented by hardware components or software components and combinations thereof.

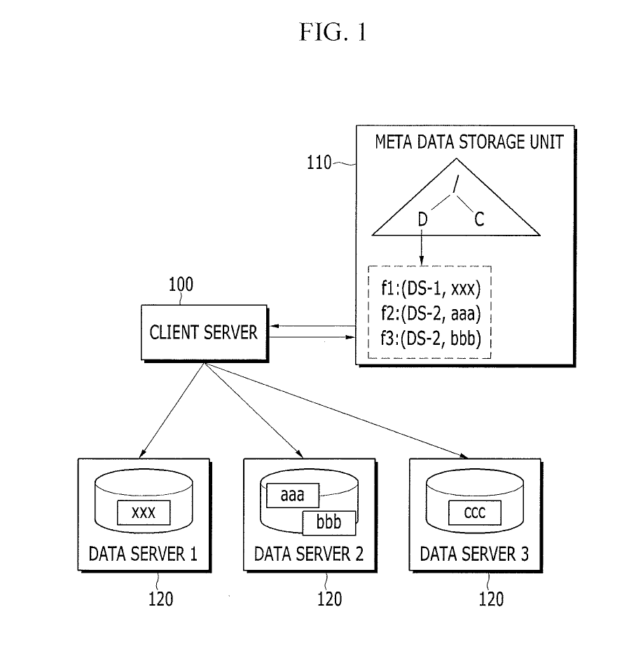

FIG. 1 is a diagram illustrating a file system according to an exemplary embodiment of the present invention.

Referring to FIG. 1, the file system according to an exemplary embodiment of the present invention includes a client server 100, a metadata storage unit 110, and a plurality of data servers 120.

The metadata storage unit 110 includes information of the data server 120 in which data is stored, and when a request of the client server 100 is input, the metadata storage unit 110 transmits position information (i.e., information of a data server in which data is stored) of data to the client server 100.

The metadata storage unit 110 according to an exemplary embodiment of the present invention may be included in the data server 120 or the client server 100, and may exist at a network as a separate object independent from the client server 100 and the data server 120.

The data server 120 includes a deletion processor and a garbage processor. When the deletion processor receives a deletion command of data from the client server 100, the deletion processor deletes the data. The garbage processor receives and stores position information of data to delete from the client server 100, and thereafter, when a data server that stores data to delete is restored, the garbage processor transmits data to delete and position information of the data to delete to the data server.

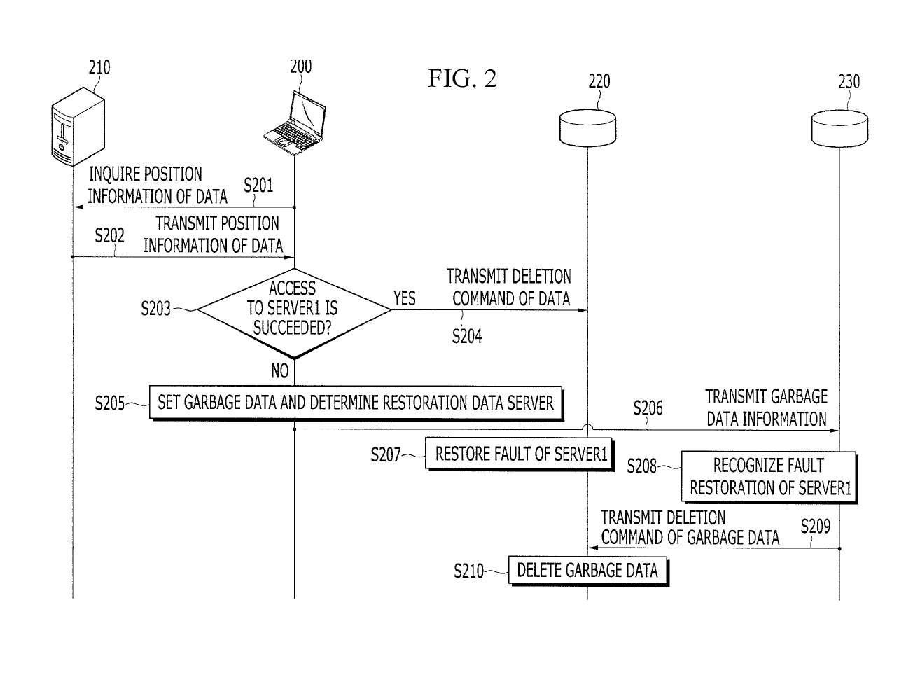

FIG. 2 is a flowchart illustrating a method of deleting garbage data according to an exemplary embodiment of the present invention.

Referring to FIG. 2, a client server 200 inquires position information of data (hereinafter referred to as “data1”) to delete to a metadata storage unit 210 (S201). Thereafter, the client server 200 receives position information of the data1 from the metadata storage unit 210 (S202) and attempts to access a data server 220 (hereinafter referred to as “server1”) at which the data1 is positioned, and determines whether access to the data server 220 has succeeded (S203).

If access to the data server 220 has succeeded, the client server 200 transmits a deletion command of the data1 to the server1 220 (S204).

However, as a fault occurs in the server1 220, if the client server 200 cannot transmit a deletion command of the data1 to the server1 220, the client server 200 sets the undeleted data1 to garbage data and determines another data server 230 (hereinafter referred to as a “restoration data server”) to store information of the garbage data (S205).

For example, when a network line state between the client server 200 and the server1 220 is unstable or when a hardware fault occurs in the server1 220, the client server 200 cannot transmit a deletion command to the server1 220.

In this case, the client server 200 determines the restoration data server 230 based on a distance from the server1 220 to the restoration data server 230. Alternatively, the restoration data server 230 may be determined according to a random extraction method or a round robin (RR) scheduling method.

Thereafter, the client server 200 transmits garbage data information to the restoration data server 230 (S206).

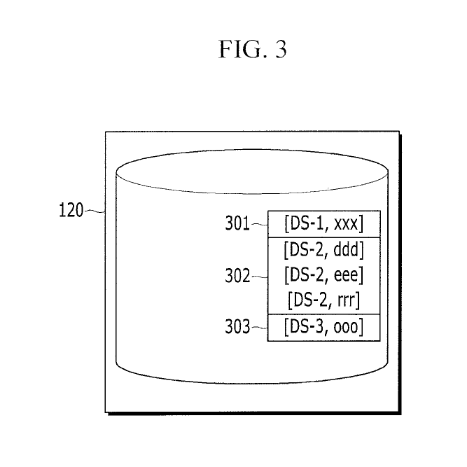

FIG. 3 is a diagram illustrating garbage data information according to an exemplary embodiment of the present invention.

Referring to FIG. 3, the garbage data information includes identification (ID) (xxx, ddd, eee, rrr, and ooo) of garbage data and position information (DS-1, DS-2, and DS-3) of garbage data.

That is, garbage data information1 301 represents that data “xxx” that is stored at DS-1 is not deleted, garbage data information2 302 represents that data “ddd”, “eee”, and “rrr” that are stored at DS-2 are not deleted, and garbage data information3 303 represents that data “000” that is stored at DS-3 is not deleted.

The garbage data information may be stored at a permanent storage space such as a hard disk drive of a restoration data server, and may be expressed with a list structure or a tree structure.

Referring again to FIG. 2, thereafter, when a state of the server1 220 is restored (S207), the restoration data server 230 that stores garbage data information recognizes fault restoration of the server1 220 (S208), and transmits a deletion command of garbage data to the server1 220 (S209).

In this case, the restoration data server 230 periodically determines whether it is possible to access the server1 220 and thus recognizes if the server1 220 is restored. Alternatively, when the restored server1 220 notifies all data servers that are included in a distributed network of a restoration fact thereof or when the restored server1 220 notifies a randomly selected data server of a restoration fact thereof, the selected data server may notify all data servers that the server1 220 has been restored.

The restoration data server 230 may transmit a deletion command of garbage data in a bundle on a server basis. In this case, transmission efficiency in which the restoration data server 230 transmits garbage data information to the server1 220 can be improved.

Thereafter, the server1 220 deletes data according to a deletion command of the garbage data (S210).

As described above, according to an exemplary embodiment of the present invention, because it is impossible to access a data server, data to delete is not deleted and thus when a garbage file is generated, the generated garbage file can be completely deleted. In this case, by performing a deletion operation of a garbage file in a distributed data server unit, operation efficiency can be maximized.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A method of deleting data in a distributed network system, the method comprising:
attempting deletion of the data in a first data server in which the data is stored among a plurality of data servers;
setting the data to garbage data when the data is not deleted in the first data server;
storing information of the garbage data in a second data server of the plurality of data servers; and
deleting the data from the first data server based on the garbage data when the first data server is restored.

2. The method of claim 1, wherein the attempting of deletion of the data in the first data server comprises:
searching for the plurality of data servers through metadata information representing position information of the data; and
instructing deletion of the data to the first data server.

3. The method of claim 1, wherein the setting of the data to garbage data occurs when the data is not deleted in the first data server when a network line to the first data server is unstable or when a fault occurs in hardware of the first data server.

4. The method of claim 1, wherein the information of the garbage data comprises identifier and position information of the garbage data.

5. The method of claim 1, wherein the storing information of the garbage data in the second data server comprises:
determining the second data server based on a distance to the first data server; and
storing information of the garbage data at the determined second data server.

6. The method of claim 1, wherein the storing information of the garbage data in the second data server comprises:
determining the second data server according to a round robin (RR) scheduling method in the remaining plurality of data servers, excluding the first data server; and
storing information of the garbage data at the determined second data server.

7. The method of claim 1, wherein the deleting of the data from the first data server based on the garbage data comprises:
periodically determining whether the first data server is restored; and
deleting the data based on information of the garbage data.

8. The method of claim 1, wherein the deleting of the data from the first data server based on the garbage data further comprises:
receiving a restoration fact of the first data server that is notified to data servers included in the distributed network system; and
deleting the data based on information of the garbage data.

9. The method of claim 1, wherein the deleting of the data from the first data server based on the garbage data further comprises:
combining the information of the garbage data comprising the same position information among the garbage data that is stored at the second data server and transmitting the information of the garbage data to the first data server; and
deleting the data based on the information of the garbage data.

10. A distributed network system that manages distributedly stored data, the distributed network system comprising:
a client server configured to search for a data server in which the data is stored and transmit a deletion command of the data, and set undeleted data to garbage data when the data is not deleted;
a first data server configured to store the data and receive a deletion command of the data or the garbage data to delete the data; and
a second data server configured to store information of the garbage data and transmit a deletion command of the garbage data to the first data server based on the information of the garbage data.

11. The distributed network system of claim 10, further comprising a metadata storage unit configured to store metadata representing position information of the data and transmit the metadata to the client server when a request of the client server exists.

12. The distributed network system of claim 10, wherein the client server sets the undeleted data to garbage data when the data is not deleted in the first data server when a network line to the first data server is unstable or when a fault occurs in hardware of the first data server.

13. The distributed network system of claim 10, wherein the information of the garbage data comprises identifier and position information of the garbage data.

14. The distributed network system of claim 10, wherein the client server stores information of the garbage data at a second data server that is determined based on a distance to the first data server.

15. The distributed network system of claim 10, wherein the client server stores information of the garbage data at the second data server that is determined according to an RR method among the remaining plurality of data servers, except for the first data server.

16. The distributed network system of claim 10, wherein the second data server periodically determines whether the first data server is restored and transmits a deletion command of the garbage data to the first data server when the first data server is restored.

17. The distributed network system of claim 10, wherein the second data server transmits a deletion command of the garbage data to the first data server, when the first data server notifies a data server that is included in the distributed network system of a restoration fact thereof.
